(19) United States
(12) Patent Application Publication
(10) Pub. No.: US 2011/0069007 A1
(43) Pub. Date: Mar. 24, 2011

(54) POINTING DEVICE

(76) Inventors: RICHARD BAXTER, Elm (GB); Steven Lavache, Ware (GB)

(21) Appl. No.: 12/881,097

(22) Filed: Sep. 13, 2010

Related U.S. Application Data
(63) Continuation of application No. PCT/GB2009/000647, filed on Mar. 11, 2009.

(51) Int. Cl. G06F 3/033

(52) U.S. Cl. 345/158

(57) ABSTRACT

A gyroscopic pointing apparatus for an electronic device, particularly a games console, that is provided with means to detect when the mobile component is pointing at the screen upon which it controls a cursor to provide a mechanism to correct for drift in gyroscope readings and an improved method of dynamically recalibrating the zero point of the gyroscopes. The pointing detection mechanism may be provided by the combination of an infra-red LED and an infra-red sensor in either permutation on the mobile component and fixed component respectively.

### Cross-Reference to Related Applications

This application is a continuation of and claims the benefit of International Application Number PCT/GB2009/000647 tiled Mar. 11, 2009, which is hereby incorporated herein by reference in its entirety.

### FIELD OF THE INVENTION

This invention relates to pointing apparatus for use with display equipment.

### DESCRIPTION OF THE RELATED ART

Pointing devices for controlling the position of a cursor on a display device have been used for decades. A variety of techniques have been used to implement these pointing devices, the devices becoming more sensitive, user-friendly and ergonomic as technology has progressed. With the recent development of reliable wireless communication between human input devices and the equipment they control, a demand has arisen for a reliable wireless pointing device that can be hand-held and control a cursor on a display by simply pointing the device at the display.

Nintendo's® Wii® Remote is one example of such a pointing device. in the Wii Remote there is an image sensor that detects the two groups of infra-red LEDs present in a sensor bar, which is placed next to the screen connected to a Wii console. This allows the Wii Console to determine the direction in which the Wii Remote is pointing and display a cursor on the screen corresponding with the pointing direction. However, such a system requires an expensive, complicated image sensor in every controller that is to be used with the console, and requires the controller to be no more than about 3 m from the Sensor Bar in order to function correctly. Furthermore, relaying the information from the image sensor to the console may require a relatively high bandwidth connection, adding complexity and cost.

Other attempts to provide such a pointing device have been based around the use of gyroscopes in the pointing device to detect its motion. The problem with such an approach is that gyroscope readings tend to drift over time due to rounding errors and noise, leading to inaccurate readings. In the case where such problems are not addressed, the user of such an input device can end up pointing the device substantially away from the display on which the cursor the user is controlling is displayed, resulting in un-intuitive use. Furthermore, the zero point of a gyroscope can drift slightly over time, necessitating dynamic recalibration of the device.

### BRIEF SUMMARY OF EMBODIMENTS OF THE INVENTION

It is an object of this invention to provide a pointing apparatus which will go at least some way in addressing the aforementioned problems; or which will at least provide a novel and useful alternative.

According to a first aspect of the invention, there is provided pointing apparatus comprising a fixed (i.e., stationary) component and a mobile component, the mobile component having a gyroscope for detecting its rotation, the pointing apparatus determining a pointing direction for the mobile component based on the readings from the gyroscope, the pointing apparatus being adapted in use to detect when the mobile component changes state from pointing away from the fixed component to pointing substantially at the fixed component, this detection being used to reset the determined pointing direction for the mobile component by: defining a region of influence around the fixed component; determining the direction of rotation of the mobile component at the point in time when its pointing at the fixed component was detected; extrapolating the negative of that direction of rotation from a point in the region of influence to the edge of the region of influence; and setting the pointing direction of the mobile component, at the point in time when its pointing at the fixed component was detected, as the point where the negative of the direction of rotation met the edge of the region of influence.

Preferably, the pointing apparatus further comprises a light receiver sensitive to at least one wavelength of light and a light emitter of at least one wavelength of light, the light receiver and light emitter being located in a respective one of each component, wherein the detection of when the mobile component is being pointed substantially at the fixed component is carried out using the signals from the light receiver. This provides a simple and effective mechanism for determining when the mobile component is pointed substantially at the fixed component.

Preferably, the light receiver is sensitive to at least one wavelength of infra-red light and the light emitter emits at least one wavelength of infra-red light. The use of infra-red light has the advantage that it is a frequency of light normally invisible to the human eye, and does not interfere with light conditions in the room it is used.

Optionally, the light receiver is a two-dimensional (2D) light receiver such as a camera. This allows richer interaction between a user and a games console, and may also offer additional functionality beyond that used in this invention.

Optionally, the 2D light receiver may be used to establish the starting pointing direction of the mobile component by detecting the initial direction of approach of the light emitter. This allows non-linear movements of the mobile component to be easily tracked.

Preferably, the gyroscope is used in conjunction with the 2D light receiver to establish the starting pointing direction of the mobile component. This provides a robust and accurate method for determining this starting pointing direction.

Alternatively, the starting pointing direction of the mobile component may be determined using an ultrasonic sensor.

Additionally, the 2D light receiver may be used to determine when the mobile component is substantially stationary for recalibrating the zero point of the gyroscope. This allows for more accurate recalibration of the gyroscope.

Optionally, the mobile component may further comprise an accelerometer for detecting when the mobile component is in a steady state, such as being stationary or steadily moving, for recalibrating the zero point of the gyroscope.

According to a second aspect of the invention, there is provided a method for ameliorating the effects of drift in the readings of a pointing apparatus, the pointing apparatus comprising a fixed component and a mobile component, the mobile component further comprising acceleration sensing means such as a gyroscope, the method comprising defining a region of influence around said fixed component; detecting when the mobile component is pointed at said fixed component; determining from the readings of the acceleration sensing means the vector of rotation direction of the movement of the mobile component towards the fixed component; and determining a new starting pointing direction of the mobile component by extrapolating the negative of the vector of rotation direction from the center of the region of influence until it reaches the edge of the region of influence.

Optionally, the method may comprise an additional step of feeding readings from the acceleration sensing means into a recalibration algorithm when the mobile component is substantially stationary.

According to a third aspect of the invention there is provided a pointing apparatus comprising a light receiver sensitive to at least one wavelength of light and a light emitter of at least one wavelength of light, the apparatus comprising a fixed component and a mobile component separate from one another, the light receiver and light emitter being located in a respective one of each component; the mobile component further comprising a gyroscope; the apparatus being arranged such that in use the light receiver and light emitter detect when the mobile component is being pointed substantially at the fixed component, whereupon the apparatus uses readings from the gyroscope to determine the precise pointing direction of the mobile component.

The gyroscope may be used to establish the starting pointing direction of the mobile component, by determining the vector of rotation of the mobile component upon the light receiver detecting light from the light receiver. This provides a simple and effective way of correcting for drift in the gyroscope readings.

### BRIEF DESCRIPTION OF THE DRAWINGS

The invention will now be described, by way of example, with reference to the drawings in which:

FIG. 1 is a schematic perspective diagram illustrating an overview of a pointing apparatus in accordance with the invention;

FIG. 2 is a schematic diagram illustrating a method of correcting for drift in the gyroscopic readings of a pointing apparatus according to the invention;

FIG. 3 is a schematic block diagram illustrating the mobile component of a pointing apparatus according to a first embodiment of the invention; and

FIG. 4 is a schematic block diagram illustrating the mobile component of a pointing apparatus according to a second embodiment of the invention.

### DETAILED DESCRIPTION OF THE EMBODIMENTS OF THE INVENTION

The present embodiments depict a pointing device for use with a video games console. However, the principles described may readily be adapted for use in other applications such as a pointing device for a personal computer, or other electronic devices capable of accepting a pointing input.

The term “gyroscope”, and derivatives thereof, is used herein to refer to acceleration or motion detecting means having a similar function to a gyroscope or gyroscopic sensor. This term is used to include, but is in no means limited to, devices such as gyroscopes; fiber optic gyroscopes; laser gyroscopes; vibrating structure gyroscopes; hemispherical resonator gyroscopes; quartz rate sensors and magnetohydrodynamic sensors. The term is intended to encompass a single such detecting means or group thereof acting jointly or independently. This term is also used to refer to accelerometers arranged to produce similar readings to those of gyroscopes, which may he through an electronic or software interface.

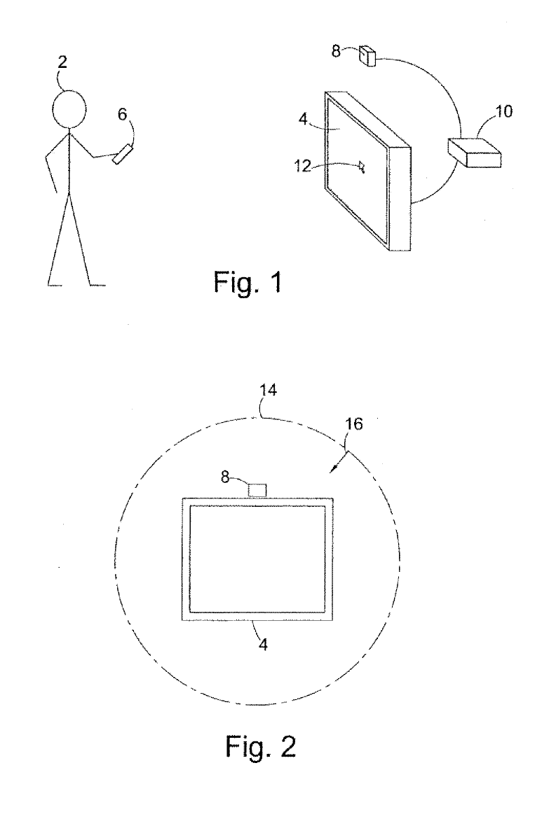

FIG. 1 illustrates an overview of a pointing apparatus according to the invention. A user 2 stands or sits in front of a display device 4, holding a mobile component 6 of the pointing apparatus. There is a fixed component 8 of the pointing apparatus positioned near the display device 4, which is connected through a wire (or other communication means) to a games console 10 which is itself connected to display device 4. Games console 10 sends signals representing an image to be displayed to display device 4 which displays the image. The pointing apparatus provides a mechanism for the user to interact with the image displayed on display device 4.

Games console 10 is capable of rendering a cursor 12, or other pointing indicator such as a cross-hair, for display on display device 4. This cursor 12 may be present continuously; only visible when required by an application on games console 10 or only visible when the pointing apparatus is in use. Alternatively, the cursor may he invisible to the user. Mobile component 6 contains a gyroscope fir detecting the movements of mobile component 6 and moving the cursor 12 on display device 4 in a corresponding manner. The readings from the gyroscope in mobile component 6 are communicated to games console 10 by a wireless RF connection (or other communication means). The signal sent to the games console 10 may be the raw readings returned from the sensors in mobile component 6, or alternatively these readings may be processed before sending so as to, for example, reduce the bandwidth needed to send the signals. According to the invention, there is provided a pointing detection mechanism for detecting when mobile component 6 is being pointed substantially at fixed component 8, and hence display device 4. Use of this pointing detection mechanism enables the pointing apparatus to correct for the drift in gyroscope readings due to rounding errors and other errors.

Correction for drift in the gyroscope can be achieved using the following method. Whenever the mobile component 6 changes state from pointing away from display device 4 to pointing towards display device 4, the location of the cursor on the screen can be re-established. To do this, first a vector of rotation is generated based on the x and y components of the readings from the gyroscope in mobile component 6. This gives the direction in which mobile component 6 was moved to bring it to bear on display device 4.

There is defined around the display device 4 a “region of influence” 14, shown in FIG. 2. This region of influence could equally be the to be around the fixed component 8 rather than display device 4. This region of influence approximately describes the region of pointing directions in which the pointing detection mechanism detects that the mobile component 6 is pointing towards fixed component 8. The region of influence may, in some cases, be a circle, square, rectangle or more generally an oval shape. Of course, the region of influence may he a different shape from those listed depending on, for example, the type of pointing detection used. The region of influence may be dynamically adjusted depending on application using other positioning information. It is preferable that the center of the region of influence 14 is in the same location as the center of the display device 4, and consequently a correction translation may be applied to the region of influence as the fixed component 8 is not at the center of display component 4. This can be achieved by having user 2 provide the approximate location of fixed component 8 using various methods, such as selecting an option from a menu screen.

If the assumption is made that the mobile component 6 is being moved to point towards the center of display device 4, which is not always the case but is generally an acceptable assumption to make, then the vector of rotation 16 can be used to define a point on the edge of this region of influence. This is done by taking the negative value of the vector of rotation 16 and projecting it from the center of display device 4 until it reaches the edge of region of influence 14. The center of display device 4 is preferably at the center of the region of influence, but alternatively may be another point in the region of influence depending on, for example, the shape of the region of influence. The cursor 12 can then be started from this point, providing a cursor 12 which is substantially in the direction pointed by mobile component 6. Once the pointer is re-positioned its position may then he adjusted or moved based on the last gyroscope reading and the time interval since that gyroscope reading. This action helps compensate for synchronization issues between sensor and gyroscope readings. The detection of extremely rapid acceleration and deceleration events when entering and remaining in the region of influence 14 can allow an application on games console 10 to assume that the user is pointing towards the center of display device 4. Under this assumption, the application can choose to reposition the cursor 12 at or near the center of display device 4. As, during use, the mobile component 6 will often be pointed away from the display device 4, this method provides correction for drift in the readings from the acceleration sensors. The pointing detection mechanism can, as will be described later, be achieved simply and easily using low cost components, resulting in a robust pointing apparatus. The simplicity of the pointing detection reduces the bandwidth requirements of the communication link between mobile component 6 and games console 10, and is robust over relatively long distances.

It is also possible to detect an invalid break in the pointing detection, such as might be caused by a person walking in between user 2 and fixed component 8. In this case, the pointing signal will be rapidly removed without any corresponding signals on the gyroscope. It is thus possible to maintain pointing control in this situation until pointing detection stored or a predetermined period of time has passed, which may be a function of how much the mobile component 6 is moved during this time.

A simple arrangement to implement this pointing detection mechanism is an infra-red emitter and an infra-red receiver. However, the pointing detection mechanism may also be implemented using an emitter and sensor operating at other wavelength of light, such as visible light or any of the ultra-violet wavelengths. The term “light” is used herein to refer to both visible light and electromagnetic radiation having wavelengths in the invisible light regions of infra-red and ultra-violet, and any wavelengths in between. In the case that a 2D device, such as a CCD camera, is used as an infra-red receiver, an improved method of dynamically recalibrating the zero reference point of the gyroscope can be carried out. Recalibration of a gyroscope can be carried out using various known filters and averages of readings from the gyroscope. These techniques can be significantly improved by only incorporating readings from the gyroscope when it is known to be stationary, or only slightly moving. The use of a 2D infra-red sensor means that the image of the infra-red emitter can be analyzed to establish when the mobile component 6 has very little or no movement, and thus only feed readings from the gyroscope into the calibration algorithms at these times. Furthermore, the use of a 2D infra-red sensor allows refinement of the starting location of cursor 12 when mobile component 6 is pointed at display device 4, by detecting the image of the infra-red emitter and its location in space.

This detection of when mobile component 6 is not moving can also be achieved by including an accelerometer in mobile component 6. This can detect when the mobile component 6 is either substantially stationary or moving at a steady speed, under both of which conditions the recalibration can be effectively performed. This allows a simple and effective way of recalibrating the gyroscope without the need for a 2D sensor.

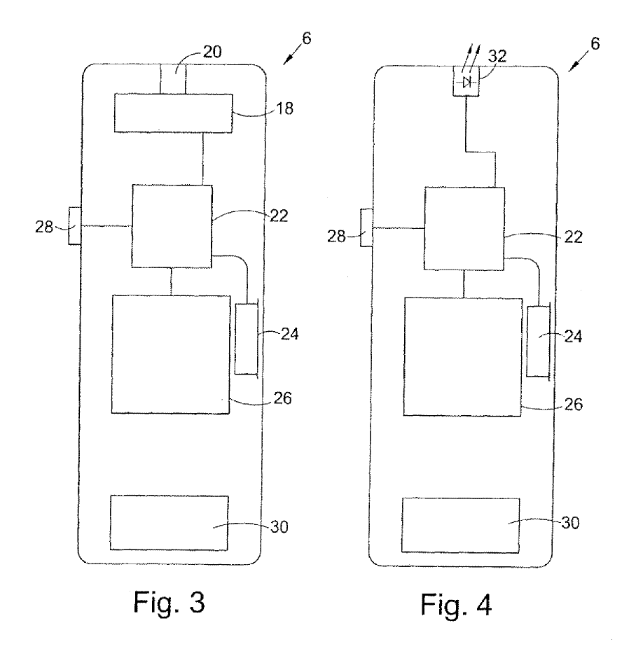

FIG. 3 is a schematic block diagram of the mobile component 6 according to a first embodiment of the invention. It has an infra-red sensor 18 at its front (the end that is pointed towards display device 4 in use) for determining if it is pointing at display device 4 by detecting infra-red radiation emitted by a corresponding infra-red emitter on fixed unit 8. In this embodiment, infra-red sensor 18 is a simple photodiode sensitive to IR, and its detection of light is rendered directional and specific to IR by the window 20 through which it can detect incoming light. The photodiode could easily be replaced by a photocapacitor, light-dependant resistor, phototransistor, or a more complicated device such as a 2D CCD camera. In order that the pointing detection mechanism work efficiently, it is preferable that the window 20 (or equivalent structure or component) renders the sensitivity of sensor 14 highly directional.

In this configuration, the infra-red emitter on fixed unit 8 need only be a simple IR LED or group thereof for sufficient brightness. In order to reduce the possibility of a false reading from the IR sensor 18, the IR LED on fixed unit 8 may be tuned to a particular frequency or oscillating with known frequency. This oscillation may be constant, or occur on request by the games console 10. The oscillation may take place as a full on/off cycle, or alternatively simply vary the intensity of illumination of the IR LED. In the extreme, the LED may be simply blinked off for a brief period on request from the console 10. This can be used to distinguish between when pointing device 6 is pointing towards display device 4 (and hence fixed unit 8) and when it is pointing towards another powerful IR source such as a halogen light-bulb or the sun. The previously mentioned ability to detect an invalid break in the pointing signal can be used to ensure that transmission of control signals is not intermittent in the case that the IR LED is oscillating.

IR sensor 18 is connected to processor 22 that determines when the mobile component 6 is pointing at display device 4. When it is, processor 22 starts sending, via RF transceiver 24, signals from gyroscope 26. These signals may be processed before sending so as to reduce the amount of data sent. Processor 22 may send various signals whether or not the mobile component 6 is pointing at display device 4 depending on the application to which the apparatus is put. Mobile unit 6 further has a button 28 for user input. This button can be used to send a signal to the games console 10 that can be used as an indication to perform an action (such as selecting an option on-screen). Alternatively, button 28 may be used to perform internal functions within mobile unit 6, such as stopping signals being sent from the gyroscope 26 so as to hold the cursor 12 in one position on display device 4. Mobile component 6 may be powered by a rechargeable battery 30, which has connections for providing power to each internal component (not shown). The functions of processor 22 need not necessarily be implemented in mobile component 6, signals from all of the subunits could be continuously sent via the communication link and the processing functions of processor 22 could be carried out in fixed component 8 or games console 10.

The use of a simple IR LED in fixed component 8 for the pointing detection mechanism means that more than one mobile component 6 can be used with the same fixed component 8. This leads to simple implementation of multi-user interaction with games console 10. This is the case whether the IR sensor 18 in mobile unit 6 is a simple photodiode or a 2D CCD camera, although a photodiode offers a simpler, cost effective system.

FIG. 4 is a schematic block diagram of the mobile component 6 according to a second embodiment of the invention. It has an infra-red LED 32 at its front (the end that is pointed towards display device 4) for detection by fixed component 8 to determine if it is pointing at display device 4. In order for this embodiment of the pointing detection mechanism to work, the light emitted by infra-red LED at its front is preferably directional and substantially collimated. An infra-red sensor on fixed component 8 completes the pointing detection mechanism. If the pointing detection apparatus is to be used with more than one mobile component 6, such as in a multi-user game, the infra-red sensor on component 8 is preferably able to discriminate between the infra-red LEDs of different mobile components 6. This may be achieved by oscillating the LEDs at a frequency specific to each mobile component 6 or simply outputting light of a different frequency on each mobile component 6, or by using the other identifying LED oscillations described above. In the case that the infrared sensor on fixed component 8 is a 2D sensor such as a CCD camera, each mobile component 6 may feature an array of infra-red LEDs that are differently illuminated on each mobile component 6 to distinguish them. Alternatively, different discriminatory means may be used such as ultrasound or RF direction or range finding.

In this embodiment, with an infra-red LED 32 or array thereof at the front, mobile component 6 is significantly simpler than that of the first embodiment and has lower processing requirements. Consequently, processor 18 may be substantially more simple than in the first embodiment, but is still useful for controlling the various functions of mobile component 6. As in the first embodiment, mobile component 6 has a button 24, an RF transceiver 20, gyroscope 22 and battery 26. Mobile component 6 may also include moving parts such as a vibrator, or light sources to improve its interactivity as a controller.

Both of the described embodiments therefore provide a mechanism for detecting when the mobile component 6 is pointing towards display device 4, allowing the methods described herein to be used with them so as to mitigate problems with gyroscopic drift. The skilled man will realize that there are other modifications that may be made to the described embodiments within the scope of the invention, and the various described features may be combined in different ways other than the examples set out above.

What is claimed is:

1. A pointing apparatus comprising a stationary component and a mobile component, the mobile component having a gyroscope for detecting its rotation, the pointing apparatus determining a pointing direction for the mobile component based on readings from the gyroscope, and the pointing apparatus being adapted to detect when the mobile component changes state from pointing away from the stationary component to pointing substantially at the stationary component, this detection being used to reset the determined pointing direction for the mobile component by:
monitoring a region of influence around the stationary component;
determining the direction of rotation of the mobile component at the point in time when its pointing at the stationary component was detected;
using the direction of rotation to extrapolate from a point in the region of influence to the edge of the region of influence; and
setting the pointing direction of the mobile component, at the point in time when its pointing at the stationary component was detected, as the point where the negative of the direction of rotation met the edge of the region of influence.

2. A pointing apparatus according to claim 1, further comprising:
a light receiver sensitive to at least one wavelength of light; and
a light emitter of at least one wavelength of light, the light receiver and light emitter being located in a respective one of each component, wherein the detection of when the mobile component is being pointed substantially at the stationary component is carried out using the signals from the light receiver.

3. A pointing apparatus according to claim 2, wherein the light receiver is sensitive to at least one wavelength of infra-red light and the light emitter emits at least one wavelength of infra-red light.

4. A pointing apparatus according to claim 2, wherein the light receiver is a two-dimensional (2D) light receiver such as a camera.

5. A pointing apparatus according to claim 4, wherein the 2D light receiver is used to establish the starting pointing direction of the mobile component by detecting the initial direction of approach of the light emitter.

6. A. pointing apparatus according to claim 5, wherein the gyroscope is used in conjunction with the 2D light receiver to establish the starting pointing direction of the mobile component.

7. A pointing apparatus according to claim 4, wherein the 2D light receiver is used to determine when the mobile component is substantially stationary for recalibrating the zero point of the gyroscope.

8. A pointing apparatus according to claim 4, wherein the starting pointing direction of the mobile component is established by using the vector of rotation of the mobile component to extrapolate from the center of a region of influence defined around the stationary component to its edge, the point where the negative of the vector of rotation of the mobile component crosses the edge of the region of influence giving the starting pointing direction.

9. A pointing apparatus according to claim 2, wherein the gyroscope is used to establish the starting pointing direction of the mobile component by determining the vector of rotation of the mobile component upon the light receiver detecting light from the light receiver.

10. A pointing apparatus according to claim 1, wherein the starting pointing direction of the mobile component is determined using an ultrasonic sensor.

11. A. pointing apparatus according to claim 1, wherein the mobile component further comprises an accelerometer for detecting when the mobile component is in a steady state, such as being stationary or steadily moving, for recalibrating the zero point of the gyroscope.

12. A method for ameliorating the effects of drift in readings of a pointing apparatus, the pointing apparatus comprising a stationary component and a mobile component, the mobile component further comprising acceleration sensing means such as a gyroscope, the method comprising:
monitoring a region of influence around the stationary component;
detecting when the mobile component is pointed at the stationary component;
determining from readings of the acceleration sensing means the vector of rotation direction of the movement of the mobile component towards the stationary component; and
determining a new starting pointing direction of the mobile component by using the vector of rotation direction to extrapolate from the center of the region of influence until it reaches the edge of the region of influence.

13. A method according to claim 12, comprising an additional step of:
feeding readings from the acceleration sensing means into a recalibration algorithm when the mobile component is substantially stationary.

14. A method according to claim 12, further comprising:
detecting when a reading from the acceleration sensing means exceeds a threshold value; and
defining the pointing direction of the mobile component as being towards the center of the region of influence.

15. A hand-held controller for use as a pointing device, comprising a gyroscope for detecting its rotation, wherein a pointing direction for the hand-held controller is based on readings from the gyroscope, and the hand-held controller is configured to inform in a pointing apparatus of a change in state when the hand-held controller goes from pointing away from a stationary component to pointing substantially at the stationary component.

16. A hand-held controller according to claim. 15 further comprising a light receiver sensitive to at least one wavelength of light.

17. A hand-held controller according to claim 16, wherein the light receiver is sensitive to at least one wavelength of infra-red light.

18. A hand-held controller according to claim 16, wherein the light receiver is a two-dimensional (2D) light receiver such as a camera.

19. A hand-held controller according to claim 15, further comprising an ultrasonic sensor.

20. A hand-held controller according to claim 15, further comprising an accelerometer for detecting when the hand-held controller is in a steady state, such as being stationary or steadily moving, for recalibrating the zero point of the gyroscope.

21. A hand-held controller according to claim 15, further comprising a light emitter of at least one wavelength of light.

22. A hand-held controller according to claim 21, wherein the light emitter emits at least one wavelength of infra-red light

23. A pointing apparatus comprising:
a light receiver sensitive to at least one wavelength of light and a light emitter of at least one wavelength of light; and
a stationary component and a mobile component separate from one another;
the light receiver and light emitter being located in a respective one of each component, the mobile component further comprising a gyroscope, the apparatus being arranged such that the light receiver and light emitter detect when the mobile component is being pointed substantially at the stationary component, whereupon the apparatus uses readings from the gyroscope to determine the precise pointing direction of the mobile component.
